(19) United States
(12) Patent Application Publication
(10) Pub. No.: US 2003/0207154 A1
(43) Pub. Date: Nov. 6, 2003

(54) Magnetic recording medium and magnetic disc drive

(75) Inventor: Kazumasa Shimoda, Isehara (JP)

Correspondence Address: Patrick G. Burns, Suite 2500, 300 South Wacker Drive, Chicago, IL, 60606, US

(73) Assignee: FUJITSU LIMITED, Kanagawa, JP

(21) Appl. No.: 10/429,366

(22) Filed: May 5, 2003

Related U.S. Application Data
(62) Division of application No. 09/992,951, filed on Nov. 16, 2001, now abandoned.
Application No. 09/992,951 is a continuation of application No. PCT/JP99/02880, filed on May 28, 1999.

(51) Int. Cl. G11B 5/66

(52) U.S. Cl. 428/694 ML; 428/694 R

(57) ABSTRACT

The magnetic characteristic of a film of magnetic recording medium in the thermo-magnetic recording system is stabilized. After a non-magnetic film (3), a magnetic film (4) including magnetic material are laminated on a substrate (2), the magnetic recording medium (1) is annealed with the temperature higher than the heating temperature for the magnetic recording medium required for writing of data.

### BACKGROUND OF THE INVENTION

1. Field of the Invention

The present invention relates to a magnetic recording medium and a method of manufacturing the same to be used for a magnetic recording system using a hard disc or a magneto-optical disc or the like, particularly for a magnetic recording system using a thermomagnetic recording method for heating a recording area with a laser beam or the like to realize recording with a levitation type magnetic head.

2. Description of the Related Art

With remarkable increase of capacity of hard disc and magneto-optical disc in recent years, various searches are made for the method to improve recording density of a magnetic recording medium to be used. Particularly, it is requested to enhance coercive force for holding the written data. However, if a coercive force of a medium becomes larger than the write magnetic field of a magnetic head, magnetic writing effect becomes insufficient and it is impeded to realize high recording density. Therefore, the investigation is continued to find a thermomagnetic recording method in which a local coercive force is reduced for recording with a magnetic head by the spot heating of the recording area on a medium with a laser or the like. For example, the Japanese Laid-Open Patent Application No. HEI 2-37501 discloses a thermomagnetic recording method in which the temperature of the part for recording information or the peripheral part thereof is raised and a magnetic field is applied thereto in the system for recording or reproducing information with a magnetic head. Moreover, the Japanese Laid-Open Patent Application Nos HEI 3-189905, HEI 6-203303 and HEI 6-243527 disclose that a heating mechanism to realize thermomagnetic recording method is provided on a magnetic head. For example, there is disclosed a magnetic head that is not required to execute, for every recording, the positioning of the heating section and magnetic recording section by loading a semiconductor laser chip on a magnetic head and allocating the laser chip and magnetic recording element on the same straight line parallel to the rotating direction of a disc.

Here, repeated heating of the recording area of a thermomagnetic medium with laser beam or hot wind for the recording of data thereto will cause a problem that the film quality gradually changes to the thermally stable condition from the condition when a film is formed. If the film quality changes, it is in turn required to execute the tuning again to the part that is tuned for the film quality in the initial condition such as a signal processing circuit. Particularly, when the Co—Cr based magnetic material is used for a magnetic film of medium, it is assumed that the magnetic characteristic changes drastically in the recording system where heating is executed for every recording process because the magnetic characteristic such as coercive force or the like is determined depending on the condition of grain boundary diffusion of chromium (Cr). Moreover, even in the Co—Sm based or Tb—Fe based materials, it is known that change to equilibrium state from non-equilibrium state when a film is formed is generated with the repeated heating process.

Each cited reference explained above places emphasis on the thermomagnetic recording and structure of magnetic head for this purpose but does not refer to a structure and a method of manufacture for stabilizing the film quality of a magnetic recording medium.

An object of the present invention is to provide a magnetic recording medium having higher recording density. Moreover, the other object of the present invention is to provide a magnetic recording medium having a higher coercive force. Still further object of the present invention is to provide a method of stabilizing the magnetic characteristics of a film of magnetic recording medium.

### DISCLOSURE OF THE INVENTION

The problems explained above can be solved by previously annealing a medium at the temperature higher than the heating temperature for recording the data. When the medium is annealed under this temperature condition, a magnetic film changes to the equilibrium state. Thereafter, if the magnetic film is heated for information recording, any change is not almost generated in the magnetic characteristics because the heating temperature is lower than the temperature for annealing process.

Particularly, when the magnetic film is formed of the Co—Cr based material, Cr diffusion is executed sufficiently with the annealing process and therefore such diffusion is not executed even if heating process is repeated for information recording.

Moreover, the average temperature change coefficient in the temperature range from room temperature to 400° C. of a coercive force of the CoCr based material used in a magnetic recording medium for hard disc is 50 e/° C. or more, the average temperature change coefficient of the TbFe based magnetic material used in a magnetic recording medium for magneto-optical disc is 50 Oe/° C. The average temperature change coefficient of the CoSm based magnetic material is an intermediate value between those of the CoCr based material and the TbFe based material. Therefore, the average temperature change coefficient of the coercive force is preferably in the range from 5 to 50 Oe/° C.

When considering that the heating temperature of 400° C. or less is preferable to prevent the mixing due to the heating of the protection film and magnetic film of a medium and the preferable average temperature change coefficient of the coercive force in the temperature range from room temperature to 400° C. is 5 to 50 Oe/° C. as explained above, change of coercive force in this temperature range becomes 20 kOe or less. However, it is actually a rare case to find out a material having the coercive force of 20 kOe and therefore it is actually desirable to use a material having the coercive force of 10 kOe or less.

### BRIEF DESCRIPTION OF THE DRAWINGS

FIG. 1 is a cross-sectional view of a disc medium of the present invention.

FIG. 2 is a plan view of a magnetic disc drive including disc media of the present invention.

FIG. 3 is a cross-sectional view of a magnetic disc drive of FIG. 2.

FIG. 4 is a diagram showing a structure of a sputter device.

FIG. 5 is a graph showing the temperature dependence characteristic of coercive force in a magnetic disc using CoCr based alloy as a magnetic film.

FIG. 6 is a graph showing the temperature dependence characteristic of coercive force in a magnetic disc using CoSm based alloy as a magnetic film.

### PREFERRED EMBODIMENTS OF THE INVENTION

A cross-section of a magnetic recording medium 1 of the present invention is shown in FIG. 1. Namely, an underlayer film 3, a magnetic film 4 and a protection film 5 are sequentially formed on a substrate. Each film forming the magnetic recording medium 1 will be explained.

The substrate 2 is composed of a non-magnetic material and has a shape of disc. A material of substrate 2 comprehends NiP plated aluminum (including aluminum alloy) disc, glass (including reinforced glass) disc, silicon disc having a surface oxide film, SiC disc, carbon disc, plastic disc, ceramic disc or the like. Moreover, the substrate 2 having completed the texture process or not may be used. Sizes of substrate 2 are determined depending on a kind of medium requested and a disc drive as the application object and are generally set to external diameter of 40 mm to 100 mm, internal diameter of 10 mm to 25 mm and thickness of 0.5 mm to 1 mm.

The underlayer film 3 is formed of a non-magnetic material mainly composed of chromium. As a practical material, a metal material mainly composed of chromium or a chromium alloy such as CrW, CrV, CrTi, CrMo or the like may be listed. The underlayer film 3 is formed, for example, with a sputter method such as the magnetron sputter method and it is preferable particularly to introduce this sputter method to enhance the coerciver force under the condition that a DC negative bias is applied. As the adequate film forming condition, for example, the substrate temperature is set to 15° C. to 300° C., Ar gas pressure is set to 3 to 8 mTorr and DC input power is set to 100 to 300W. Moreover, it is also possible, in place of the sputter method, to introduce, for example, vacuum evaporation method and ion beam sputter method or the like. Thickness of the underlayer film 3 is determined in a wider range depending on various factors but it is preferably set in the range of 5 nm to 60 nm in order to enhance the S/N ratio. If thickness of the underlayer film is less than 5 nm, a problem is generated here that sufficient magnetic characteristic cannot be obtained and if thickness exceeds 60 nm, on the contrary, noise tends to become large.

The magnetic film 4 is formed of a Co based magetic material mainly composed of cobalt. As the practical material, Co based binary alloy such as CoCr alloy or the like, Co based ternary alloy such as CoCrPt or the like, quaternary or quinary alloy adding Ta or Nb to CoCrPt may be listed. When CoCrPtTa, for example, is applied to the magnetic film 4, a general composition example is set to chromium of 13 to 21 at %, platinum of 4 to 12 at % and tantalum of 2 to 5 at %.

The magnetic film 4 is preferably formed with the sputter method such magnetron sputter method and as the adequate film forming conditions, for example, the substrate temperature is set to 15° C. to 300° C., Ar gas pressure is set to 3 to 8 mTorr and DC power is set to 100 to 300W. Moreover, the other film forming method, for example, vacuum evaporation method and ion beam sputter method or the like may be substituted for the sputter method.

In the present invention, after the magnetic film 4 is formed, it is annealed for diffusion of Cr into the grain boundary. This annealing is executed under the condition that the substrate 2 is placed under the vacuum atmosphere. The annealing temperature is set to a value exceeding the range of 80° C. to 300° C. which is the heating temperature for recording the data but when a material having a lower softening temperature such as aluminum is used for the substrate, the annealing is executed at the temperature lower than the softening temperature (660° C. for aluminum). Moreover, when the substrate is plated with a material such as NiP which is caused to have magnetic characteristic through crystal transformation, the annealing is executed at the temperature lower than the crystal transformation temperature (370° C.) thereof. In addition, when the substrate is formed of a material having an extremely lower softening temperature such as a resin, the magnetic film 4 is irradiated with the laser beam while it is moved in the radius direction of the rotating medium 1. That is, the process to heat the local point of the magnetic film is executed for the entire part of the magnetic film 4. Local irradiation of laser beam to the magnetic film raises the irradiated area to a higher temperature but since the substrate has a large thermal capacity and is not irradiated with the laser beam, damage on the substrate 2 may be suppressed during the annealing process.

As a result of annealing, chromium (Cr) is precipitated, the magnetic film is formed for example of the CoCr based alloy, into the magnetic grain boundary and thereby the magnetic grain boundary shows non-magnetic property. Even in the existing recording medium, Cr is also precipitated to the magnetic grain boundary due to the heating at the time of recording, but this precipitation amount is larger in the annealing process of the present invention.

Here, the effect similar to that of the annealing can also be obtained by heating the substrate up to the heating temperature higher than that in the data recording when the magnetic film 4 is formed with the sputter method.

The protection film 5 is formed of a discrete carbon or a compound including carbon. For example, WC, SiC, B₄C, carbon including hydrogen and diamond-like carbon (DLC) of which higher hardness is notable may be listed. The protection film 6 is preferably formed with the sputter method such as the magnetron sputter method and as the adequate film forming conditions, for example, the substrate temperature is set to about 15 to 20 C, Ar gas pressure is set to 3 to 8 mTorr and DC power is set to 300 to 1500W. Moreover, the other film forming method, for example, vacuum evaporation method, ion beam sputter method or the like may be substituted for the sputter method. Thickness of the protection film 6 depends on various factors and can be determined in a wider range, but preferable thickness is 1 nm to 10 nm.

Here, it is also allowed that a lubricant film is formed on the protection film. The lubricant film is usually formed of a material of phlorocarbon resin and has the thickness of 0.5 nm to 5 nm.

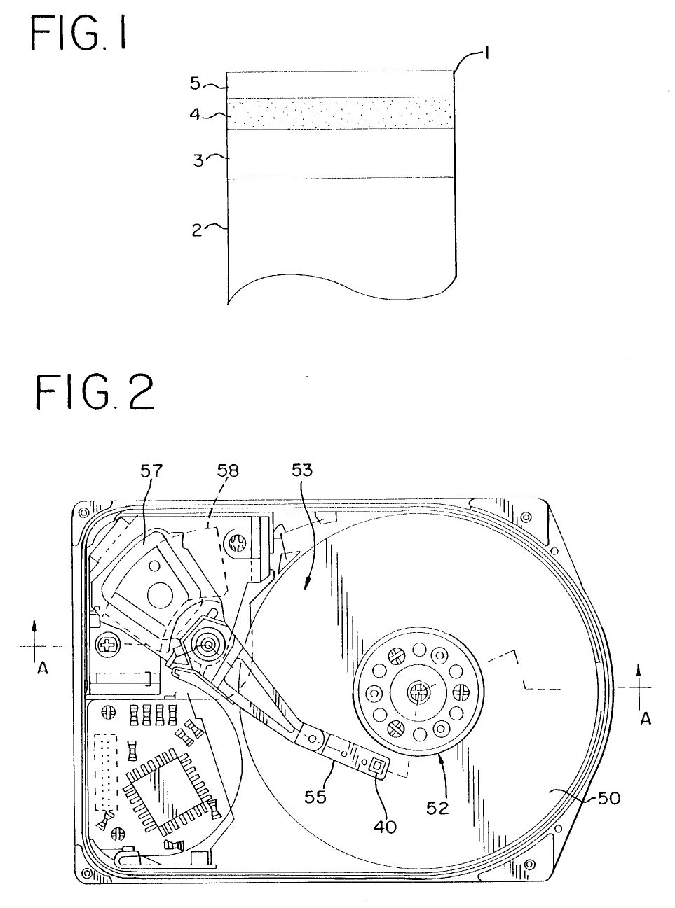

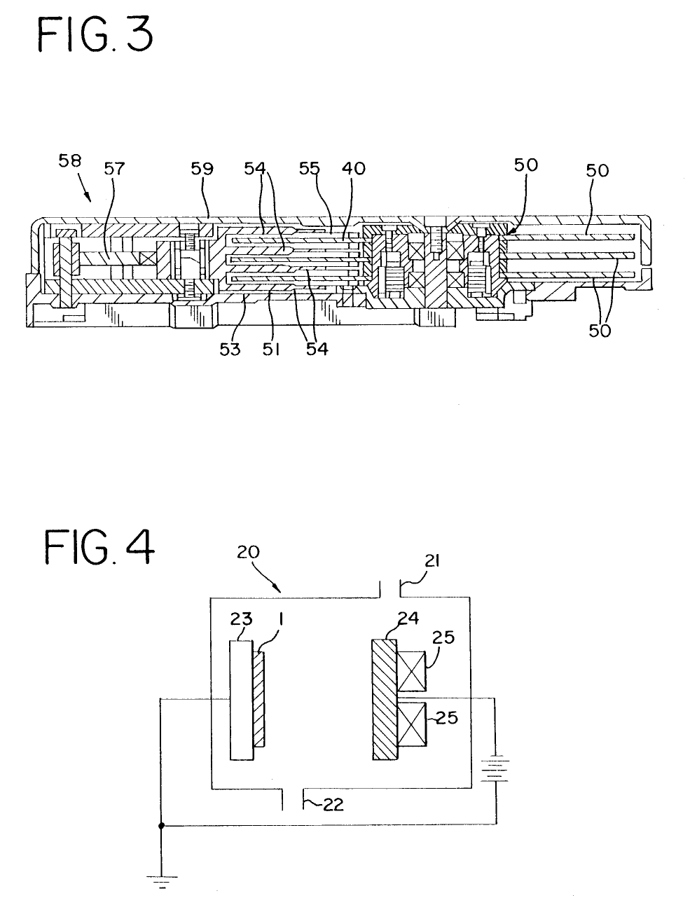

Moreover, the present invention relates to a magnetic disc drive provided with the magnetic recording media explained above and an example thereof is shown in FIG. 2 and FIG. 3. FIG. 2 is a plan view of the magnetic disc drive of the present invention under the condition that a cover is removed. FIG. 3 is a cross-sectional view along the line A-A of FIG. 7.

In these figures, reference numeral 50 designates a magnetic disc that is driven with a spindle motor 52 provided on a base plate 51.

Numeral 53 designates an actuator that is supported to rotate on the base plate 51. One end of the actuator 53 is provided with a plurality of head arms 54 formed to extend in the direction parallel to the recording surface of the magnetic disc 50. To the one end of the head arm, a spring arm is mounted. At the flexure portion of the spring arm 55, a slider 40 is attached via an insulation film not shown. The slider 40 has the structure described in the Japanese Raid-Open Patent Application Nos. HEI 3-189905, 6-203303 and 6-243527 and is also provided with a semiconductor laser chip to heat the media. At the other end of the actuator 53, a coil 57 is mounted.

On he base plate 51, a magnetic circuit 58 structured with a permanent magnet and a yoke is provided and the coil 57 is allocated within the magnetic gap of the magnetic circuit 58. Therefore, a voice coil motor (VCM) is structured with the magnetic circuit 58 and the coil 57. In addition, the upper part of the base plate 51 is covered with a cover 59.

In this embodiment, three magnetic discs are provided. The magnetic disc has a structure shown in FIG. 1, in which the underlayer film 3 consisting of a Cr-based non-magnetic material, magnetic layer 4 consisting of the Co-based alloy and protection film 5 mainly consisting of carbon are sequentially laminated on the substrate 2. Moreover, these films are previously annealed in the temperature higher than the heating temperature of the semiconductor laser.

Operations of the magnetic disc drive are explained hereunder. While the magnetic disc 50 stops, the slider 40 is also in the stop condition in contact with the waiting zone of the magnetic disc 50. Next, when the magnetic disc drive 50 is driven to rotate with the spindle motor 52, the slider levitates keeping a little gap from the disc surface owing to the air flow generated with rotation of the magnetic disc 50. Under the condition that the slider is levitated, when a current flows into the coil 57, the coil 57 generates a propulsive force to rotate the actuator 53. Thereby, the slider 40 moves to the position above the predetermined track of the magnetic disc 50, the semiconductor laser heats the write area to 80 to 300° C. to execute the writing of data. Since the magnetic disc is previously annealed in the temperature higher than this temperature range, diffusion of chromium (Cr) does not almost occur even if the disc is heated repeatedly and thereby stable magnetic characteristic may be attained.

In the present invention, the DC magnetron sputter apparatus 10 as shown in FIG. 10 has been used in order to form the predetermined films on the substrate. The sputter apparatus 10 is provided, as shown in the figure, with a gas supply port 21 for introducing a gas into the sputter chamber, an exhaust port 22, a susceptor 23 for supporting a disc substrate, a target 24 and a magnet 25.

As the first embodiment, an medium A not executing the annealing process and a medium B having executed the annealing process in the film forming process have been manufactured and the experiment has also been conducted to search change of coercive force depending on the heat of these media. The cross-sectional views of the medium A and medium B are as shown in FIG. 1. Here, the substrate 2 is formed of an aluminosilicate glass, the underlayer film 3 is formed of Cr, the magnetic film 4 is formed of CoCrPt and the protection film 5 is formed of C. The manufacturing processes of the medium A and medium B will be explained below.

The substrate 2 is formed of the alminosilicate glass substrate of the external diameter of 65 mm, internal diameter of 20 mm and thickness of 0.635 mm.

The underlayer film 3 is formed of a discrete layer of Cr that has been formed on the substrate 2 in the thickness of 50 nm under the condition that the Ar gas pressure is 5 mTorr, DC power is 300W and deposition rate is 4 nm/sec after evacuation of sputter chamber to 3×10⁻⁷Torr.

The magnetic film 4 is a discrete layer consisting of CoCrPt and is formed on the underlayer film 3 in the thickness of 20 nm under the condition that the Ar gas pressure is 5 mTorr, DC power is 150W and deposition rate is 2 nm/sec. Composition of the magnetic film 4 is the cobalt of 78 at %, chromium of 13 at % and platinum of 9 at %.

The processes until the magnetic film 4 is formed are identical for both media A and B. However, for the medium B, the annealing process has been executed for an hour at 300° C. under the vacuum condition before the protection film 5 is formed. The medium A is once released to the atmospheric condition after the magnetic film 4 is formed, while the medium B after the annealing is once performed.

After the media are released to the atmospheric condition, the protection film 5 is formed on the magnetic film 4. The protection film 5 is composed of carbon and is formed in the thickness of 8 nm on the magnetic film 4 under the condition that the Ar gas pressure is 5 mTorr and DC power is 400W, after the sputter chamber has been evacuated to 3×107Torr.

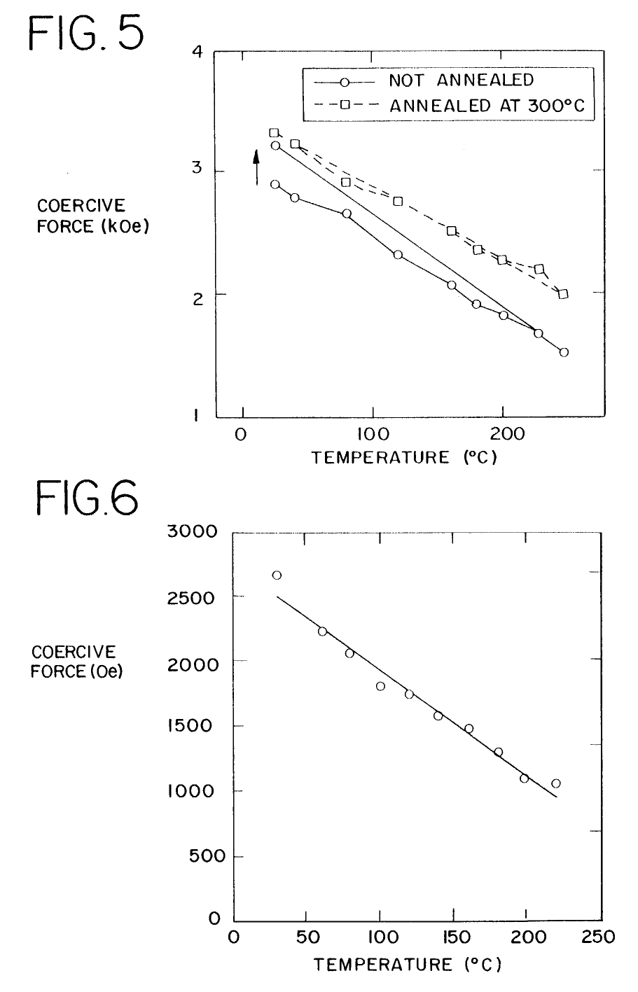

Here, the experiment has been conducted to search the temperature dependence characteristic of coercive force of the medium A and medium B manufactured through the process explained above. In this experiment, the coercive force has been measured under the temperature change of medium that the room temperature (20° C.) is once raised up to 250° C. and is then returned to the original room temperature. FIG. 5 shows a result of measurement.

As shown in FIG. 5, the annealed medium B has the coercive force higher than that of the medium A and the value higher than 2 kOe is maintained even under 200° C. Moreover, the coercive force after the temperature is once raised and is then returned to the room temperature is almost not changed in the medium B from that before the temperature is raised. That is, the medium A not annealed has changes its film quality during the heating and cooling cycles.

Moreover, temperature characteristic of coercive force has been searched through the experiment in which a magnetic recording medium of which magnetic film is composed of CoSm is heated up to 220° C. from the room temperature as the second embodiment. In the case of this magnetic recording medium, the substrate is heated up to 600° C., in place of the annealing, when the CoSm film is formed with the sputter method. FIG. 6 shows a result of the temperature characteristic.

As shown in FIG. 6, this result is characterized in that the coercive force maintains 1 kOe at 200° C.

### INDUSTRIAL APPLICABILITY OF UTILIZATION

As explained above, the magnetic recording medium of the present invention previously changes its film quality because it is annealed with the temperature higher than the temperature heated during the data recording. Therefore, there is almost no change in the magnetic characteristic due to the heating process in the subsequence use. Therefore, a troublesome work for re-tuning the signal processing system in the magnetic disc drive for writing and reading data to and from the medium is no longer required. Moreover, application of the thermal magnetic recording system can be accelerated and the coercive force and recording density can also be improved by providing the magnetic recording medium having the stable magnetic characteristic of films.

What is claimed is:

1. A magnetic recording medium characterized in that a magnetic film is laminated on a substrate via a nonmagnetic underlayer film and these elements are annealed under 300° C. or higher.

2. A magnetic recording medium where data is recorded to the heated region of said magnetic film by heating said magnetic film up to the predetermined temperature, characterized in that the annealing is conducted at the temperature higher than said heating temperature during data recording.

3. A magnetic recording medium according to claim 1 or 2, characterized in that said magnelic film is composed of a magnetic material including Co.

4. A method of manufacturing a magnetic recording medium, characterized in comprising the processes of:
laminating a non-magnetic underlayer film on a substrate;
laminating a magnetic film on said underlayer film; and
annealing said substrate where said magnetic film is laminated at 300° C.

5. A method of manufacturing a magnetic recording medium according to claim 4, characterized in that the annealing is conducted under the evacuated condition.

6. A magnetic disc drive for heating the magnetic film of a medium with the predetermined temperature and writing magnetic data to said heated region, characterized in comprising:
magnetic recording media annealed at the temperature higher than said heating temperature;
magnetic heads for recording magnetic data to said magnetic recording media;
heating heads for heating the magnetic data recording region;
spindle motor for rotating said magnetic recording media;
head sliders mounting said magnetic heads and heating heads to levitate on said magnetic disc media while said media are rotating; and
actuators for supporting said head sliders to drive said head sliders in the radius direction of said magnetic recording media.
